(19) United States
(12) Patent Application Publication
(10) Pub. No.: US 2013/0126435 A1
(43) Pub. Date: May 23, 2013

(54) ENVIRONMENTAL REMEDIATION USING LIGNIN

(71) Applicant: LIGNOL INNOVATIONS LTD., Burnaby (CA)

(72) Inventors: Alex BERLIN, Burnaby (CA); Chadrick N. GRUNERT, Vancouver (CA)

(73) Assignee: LIGNOL INNOVATIONS LTD., Burnaby (CA)

(21) Appl. No.: 13/692,742

(22) Filed: Dec. 3, 2012

Related U.S. Application Data
(63) Continuation of application No. PCT/CA2011/000648, filed on Jun. 2, 2011.
(60) Provisional application No. 61/351,230, filed on Jun. 3, 2010.

(51) Int. Cl. C02F 1/28

(52) U.S. Cl. 210/691; 210/690

(57) ABSTRACT

The present disclosure provides the use of lignin derivatives for remediation of oil discharge such as, for example, crude or refined oil spills. The present disclosure provides methods of remediating oil discharges such as, for example, accidental discharge into a marine environment.

This application is a continuation of PCT/CA2011/000648, filed Jun. 2, 2011; which claims the priority of U.S. Provisional Application No. 61/351,230, filed Jun. 3, 2010. The contents of the above-identified applications are incorporated herein by reference in their entireties.

### FIELD

This disclosure relates to lignins. This disclosure further relates to the use of lignins for environmental remediation such as, for example, remediation of oil spills.

### BACKGROUND

An oil spill is the accidental release of petroleum into the environment. On land, oil spills are usually localized and thus their effects are relatively easy to contain and remediate. Marine oil spills, in contrast, can result in significant pollution over large areas and are difficult to contain and control. Sources of oil input into seas and waterways include spills associated with oil transportation by tankers and pipelines (about 70%), as well as offshore drilling and production activities. Fortunately, large and catastrophic spills (>30,000 tons of oil) are relatively rare events. However, such episodes have the potential to cause serious ecological damage and result in long-term environmental disturbances. In addition, oil spills can have a serious adverse economic impact on coastal activities such as fishing, mariculture, and tourism. For example, marshes and sediments in Prince William Sound, Alaska retained oil from the 1989 Exxon Valdez oil spill for many years, affecting the development of fish embryos. Even after ten years, pockets of oil remained and mussels, clams, ducks and sea otters showed evidence of harm.

Several remedial responses are deployed in efforts to control oil spills. These include mechanical containment or recovery, chemical and biological methods, physical methods to clean shorelines, and scare tactic to protect wildlife.

Mechanical containment or recovery is the primary line of defense against oil spills. Containment and recovery equipment includes booms, barriers, and skimmers, as well as natural and synthetic sorbent materials. Once a spill is contained the spilled oil can be captured and stored until it can be disposed of properly. Chemical and biological methods can be used in conjunction with mechanical means for containing and cleaning up oil spills. Dispersing agents and gelling agents can be useful in helping to keep oil from reaching shorelines and other sensitive habitats. Biological agents have the potential to assist recovery in contaminated areas such as shorelines, marshes, and wetland.

The United States Environmental Protection Agency Emergency Management National Contingency Plan (Subpart J) provides a list of types of products that are authorized for use on oil discharges. Various sorbents are known including organic products (peat moss or straw, cellulose fibers or cork, corn cobs, chicken or duck feathers, WO2006/096472, US2009/0200241); mineral compounds (volcanic ash or perlite, vermiculite or zeolite); and synthetic products (polypropylene, polyethylene, polyurethane, polyester).

Despite their advantages sorbent materials are not recognized as a primary means for recovering most oil spills for a variety of reasons. For example, the application and recovery of sorbent products is labor intensive, the disposal of oily sorbents is problematic, and the cost of using sorbents can be prohibitive.

In situ burning has also been proposed as a potential method for addressing oil spills on bodies of water. Burning can be seen as a simple method to remove large amounts of oil from the sea surface (e.g. U.S. Pat. No. 6,852,234) but there are a number of issues with the technique including ignition of the oil, maintaining combustions, environmental and safety concerns. In addition slicks must be 2-3 mm thick for burning to be a viable option.

Native lignin is a naturally occurring, amorphous complex cross-linked organic macro-molecule that comprises an integral component of all plant biomass. Extracting native lignin from lignocellulosic biomass during pretreatment processes such as pulping processes generally results in lignin fragmentation into numerous mixtures of irregular components. Furthermore, the lignin fragments may react with any chemicals employed in the pulping process. Consequently, the generated lignin fractions can be referred to as lignin derivatives and/or technical lignins. As it is difficult to elucidate and characterize such complex mixture of molecules, lignin derivatives are usually described in terms of the lignocellulosic plant material used, and the methods by which they are generated and recovered from lignocellulosic plant material, i.e. hardwood lignins, softwood lignins, and annual fibre lignins.

Given that lignin derivatives are available from renewable biomass sources there is an interest in using these derivatives in certain industrial applications. For example, lignin derivatives obtained via organosolv extraction, such as those produced by the Lignol® process (e.g. Alcell®) (Lignol Innovations Ltd., Burnaby, BC, CA), have been used in rubber products, adhesives, resins, plastics, asphalt, cement, casting resins, agricultural products, oil-field products and as feedstocks for the production of fine chemicals.

### SUMMARY

The present disclosure provides the use of lignin derivatives for remediation of an oil discharge such as, for example, crude or refined oil spills. The present disclosure provides methods of remediating oil discharges such as, for example, accidental discharge into a marine or fresh water environment.

As used herein, the term “native lignin” refers to lignin in its natural state, in plant material.

As used herein, the terms “lignin derivatives” and “derivatives of native lignin” refer to lignin material extracted from lignocellulosic biomass. Usually, such material will be a mixture of chemical compounds that are generated during the extraction process.

As used herein, the term “sorbent” refers to materials that adsorb and/or absorb oil. Sorbents are generally inert and insoluble materials that remove contaminating oil through adsorption, in which the oil or hazardous substance is attracted to the sorbent surface and then adheres to it; absorption, in which the oil or hazardous substance penetrates the sorbent material; or a combination of the two.

This summary does not necessarily describe all features of the invention. Other aspects, features and advantages of the invention will be apparent to those of ordinary skill in the art upon review of the following description of specific embodiments of the invention.

### BRIEF DESCRIPTION OF THE DRAWINGS

FIG. 1 shows the effect of adding Lignol® lignin (Alcell®) to a water bath contaminated with motor oil.

FIG. 2 shows the effect of adding Lignol® lignin (Alcell®) to a water bath containing salt water and crude oil.

### DETAILED DESCRIPTION

The present disclosure provides the use of lignin derivatives as sorbents for oil. The present disclosure further provides a method for remediating an oil discharge using lignin derivatives. The present disclosure provides a method of remediating an oil discharge on water using lignin derivatives. The present disclosure further provides a method of remediating a marine or fresh water oil discharge using lignin derivatives.

Any suitable lignin derivative may be used herein. Various lignin derivatives are known including purified softwood kraft lignins (e.g. Indulin AT®); kraft lignin purified by the Lignoboost process (Innventia, Sweden); purified hardwood kraft lignins (PC1369, MeadWestvaco, USA); kraft lignins; organosolv lignins (e.g. such as those available from Lignol® e.g. Alcell®, HP-LTM); lignosulfonates or sulphite lignins (e.g. Reax85A®); soda lignins (e.g. soda lignins produced by Granit Recherche Développement SA, Switzerland); acid hydrolysis lignins produced by acid hydrolysis of wood and others (e.g. Polyphepane (Favorsky Irkutsk Institute of Chemistry SB RAS (Russia) or by the Concentrated Hydrochloric Acid Process, pilot plant CHEMATUR, ENGINEERING AB, Sweden); “Pure Lignin” produced by Pure Lignin Environmental Technology (Kelowna, BC); Curan 27-11P; Sarkandaand combinations thereof.

The present invention provides derivatives of native lignin recovered during or after pretreatment (e.g. pulping) of lignocellulosic feedstocks. The pulp may be from any suitable lignocellulosic feedstock including hardwoods, softwoods, annual fibres, and combinations thereof.

Hardwood feedstocks include Acacia; Afzelia; Synsepalum duloificum; Albizia; Alder (e.g. Alnus glutinosa, Alnus rubra); Applewood; Arbutus; Ash (e.g. F. nigra, F. quadrangulata, F. excelsior, F. pennsylvanica lanceolata, F. latifolia, F. profunda, F. americana); Aspen (e.g. P. grandidentata, P. tremula, P. tremuloides); Australian Red Cedar (Toona ciliata); Ayna (Distemonanthus benthamianus); Balsa (Ochroma pyramidale); Basswood (e.g. T. americana, T. heterophylla); Beech (e.g. F. sylvatica, F. grandifolia); Birch; (e.g. Betula populifolia, B. nigra, B. papyrifera, B. lentil, B. alleghaniensis/B. lutea, B. pendula, B. pubescens); Blackbean; Blackwood; Bocote; Boxelder; Boxwood; Brazilwood; Bubinga; Buckeye (e.g. Aesculus hippocastanum, Aesculus glabra, Aesculus flava/Aesculus octandra); Butternut; Catalpa; Cherry (e.g. Prunus serotina, Prunus pennsylvanica, Prunus avium); Crabwood; Chestnut; Coachwood; Cocobolo; Corkwood; Cottonwood (e.g. Populus balsamifera, Populus deltoides, Populus sargentii, Populus heterophylla); Cucumbertree; Dogwood (e.g. Cornus florida, Cornus nuttallii); Ebony (e.g. Diospyros kurzii, Diospyros melanida, Diospyros crassiflora); Elm (e.g. Ulmus americana, Ulmus procera, Ulmus thomasii, Ulmus rubra, Ulmus glabra); Eucalyptus; Greenheart; Grenadilla; Gum (e.g. Nyssa sylvatica, Eucalyptus globulus, Liquidambar syraciflua, Nyssa aquatica); Hickory (e.g. Carya alba, Carya glabra, Carya ovata, Carya laciniosa); Hornbeam; Hophornbeam; Ipê; Iroko; Ironwood (e.g. Bangkirai, Carpinus caroliniana, Casuarina equisetifolia, Choricbangarpia subargentea, Copaifera spp., Eusideroxylon zwageri, Guajacum officinale, Guajacum sanctum, Hopea odorata, Ipe, Krugiodendron ferreum, Lyonothamnus lyonii (L. floribundus), Mesua ferrea, Olea spp., Olneya tesota, Ostrya virginiana, Parrotia persica, Tabebuia serratifolia); Jacarandá; Jotoba; Lacewood; Laurel; Limba; Lignum vitae; Locust (e.g. Robinia pseudacacia, Gleditsia triacanthos); Mahogany; Maple (e.g. Acer saccharum, Acer nigrum, Acer negundo, Acer rubrum, Acer saccharinum, Acer pseudoplatanus); Meranti; Mpingo; Oak (e.g. Quercus macrocarpa, Quercus alba, Quercus stellata, Quercus bicolor, Quercus virginiana, Quercus michauxii, Quercus prinus, Quercus muhlenbergii, Quercus chrysolepis, Quercus lyrata, Quercus robur, Quercus petraea, Quercus rubra, Quercus velutina, Quercus laurifolia, Quercus falcata, Quercus nigra, Quercus phellos, Quercus texana); Obeche; Okoumé; Oregon Myrtle; California Bay Laurel; Pear; Poplar (e.g. P. balsamifera, P. nigra, Hybrid Poplar (Populus×canadensis)); Ramin; Red cedar; Rosewood; Sal; Sandalwood; Sassafras; Satinwood; Silky Oak; Silver Wattle; Snakewood; Sourwood; Spanish cedar; American sycamore; Teak; Walnut (e.g. Juglans nigra, Juglans regia); Willow (e.g. Salix nigra, Salix alba); Yellow poplar (Liriodendron tulipifera); Bamboo; Palmwood; and combinations/hybrids thereof.

For example, hardwood feedstocks for the present invention may be selected from Acacia, Aspen, Beech, Eucalyptus, Maple, Birch, Gum, Oak, Poplar, and combinations/hybrids thereof. The hardwood feedstocks for the present invention may be selected from Populus spp. (e.g. Populus tremuloides), Eucalyptus spp. (e.g. Eucalyptus globulus), Acacia spp. (e.g. Acacia dealbata), and combinations/hybrids thereof.

Softwood feedstocks include Araucaria (e.g. A. cunninghamii, A. angustifolia, A. araucana); softwood Cedar (e.g. Juniperus virginiana, Thuja plicata, Thuja occidentalis, Chamaecyparis thyoides Callitropsis nootkatensis); Cypress (e.g. Chamaecyparis, Cupressus Taxodium, Cupressus arizonica, Taxodium distichum, Chamaecyparis obtusa, Chamaecyparis lawsoniana, Cupressus semperviren); Rocky Mountain Douglas fir; European Yew; Fir (e.g. Abies balsamea, Abies alba, Abies procera, Abies amabilis); Hemlock (e.g. Tsuga canadensis, Tsuga mertensiana, Tsuga heterophylla); Kauri; Kaya; Larch (e.g. Larix decidua, Larix kaempferi, Larix laricina, Larix occidentalis); Pine (e.g. Pinus nigra, Pinus banksiana, Pinus contorta, Pinus radiata, Pinus ponderosa, Pinus resinosa, Pinus sylvestris, Pinus strobus, Pinus monticola, Pinus lambertiana, Pinus taeda, Pinus palustris, Pinus rigida, Pinus echinata); Redwood; Rimu; Spruce (e.g. Picea abies, Picea mariana, Picea rubens, Picea sitchensis, Picea glauca); Sugi; and combinations/hybrids thereof.

For example, softwood feedstocks which may be used herein include cedar; fir; pine; spruce; and combinations thereof. The softwood feedstocks for the present invention may be selected from loblolly pine (Pinus taeda), radiata pine, jack pine, spruce (e.g., white, interior, black), Douglas fir, Pinus silvestris, Picea abies, and combinations/hybrids thereof. The softwood feedstocks for the present invention may be selected from pine (e.g. Pinus radiata, Pinus taeda); spruce; and combinations/hybrids thereof.

Annual fibre feedstocks include biomass derived from annual plants, plants which complete their growth in one growing season and therefore must be planted yearly. Examples of annual fibres include: flax, cereal straw (wheat, barley, oats), sugarcane bagasse, rice straw, corn stover, corn cobs, hemp, fruit pulp, alfalfa grass, esparto grass, switchgrass, and combinations/hybrids thereof. Industrial residues like corn cobs, fruit peals, seeds, etc. may also be considered annual fibres since they are commonly derived from annual fibre biomass such as edible crops and fruits. For example, the annual fibre feedstock may be selected from wheat straw, corn stover, corn cobs, sugar cane bagasse, and combinations/hybrids thereof.

The derivatives of native lignin will vary with the type of process used to separate native lignins from cellulose and other biomass constituents. Lignin preparations can be obtained by, for example, (1) solvent extraction of finely ground wood (milled-wood lignin, MWL), (2) acidic dioxane extraction (acidolysis) of wood. Derivatives of native lignin can be also isolated from biomass pre-treated using (3) steam explosion, (4) dilute acid hydrolysis, (5) ammonia fibre expansion (AFEX), (6) autohydrolysis methods. Derivatives of native lignin can be recovered after biomass pretreatment (e.g. pulping) of lignocellulosics including industrially operated kraft, soda pulping (and their modifications), or sulphite pulping. In addition, a number of various pulping methods have been developed but not industrially introduced. Among them four major “organosolv” pulping methods tend to produce highly-purified lignin mixtures. The first organosolv method uses ethanol/solvent pulping (aka the Lignol® (Alcell®) process); the second organosolv method uses alkaline sulphite anthraquinone methanol pulping (aka the “ASAM” process); the third organosolv process uses methanol pulping followed by methanol, NaOH, and anthraquinone pulping (aka the “Organocell” process); the fourth organosolv process uses acetic acid/hydrochloric acid or formic acid pulping (aka the “Acetosolv” and “Formacell” processes).

It should be noted that kraft pulping, sulphite pulping, and ASAM organosolv pulping will generate derivatives of native lignin containing significant amounts of organically-bound sulphur which may make them unsuitable for certain uses. Acid hydrolysis, soda pulping, steam explosion, Lignol Alcell® pulping, Organocell pulping, Formacell, and Acetosolv pulping will generate derivatives of native lignin that are sulphur-free or contain low amounts of inorganic sulphur.

Organosolv processes, particularly the Lignol® Alcell® process, tend to be less harsh and can be used to separate highly purified lignin derivatives and other useful materials from biomass without excessively altering or damaging the native lignin building blocks. Such processes can therefore be used to maximize the value from all the components making up the biomass. Organosolv extraction processes however typically involve extraction at higher temperatures and pressures with a flammable solvent compared to other industrial processes and thus are generally considered to be more complex and expensive.

A description of the Lignol® Alcell® process can be found in U.S. Pat. No. 4,764,596 (herein incorporated by reference). The process generally comprises pulping or pre-treating a fibrous biomass feedstock with primarily an ethanol/water solvent solution under conditions that include: (a) 60% ethanol/40% water (W/W), (b) a temperature of about 180° C. to about 210° C., (c) pressure of about 20 atm to about 35 atm, and (d) a processing time of 5-120 minutes. Derivatives of native lignin are fractionated from the native lignins into the pulping liquor which also receives solubilised hemicelluloses, other carbohydrates and other extractives such as resins, phytosterols, terpenes, organic acids, phenols, and tannins. Organosolv pulping liquors comprising the fractionated derivatives of native lignin and other extractives from the fibrous biomass feedstocks, are often called “black liquors”. The organic acid and extractives released by organosolv pulping significantly acidify the black liquors to pH levels of about 5 and lower. After separation from the pre-treated lignocellulosic biomass or pulps produced during the pre-treatment process (e.g. pulping process), the derivatives of native lignin are recovered from the black liquor by flashing followed by dilution with acidified cold water and/or stillage which will cause the fractionated derivatives of native lignin to precipitate thereby enabling their recovery by standard solids/liquids separation processes. Various disclosures exemplified by U.S. Pat. No. 7,465,791 and PCT Patent Application Publication No. WO 2007/129921, describe modifications to the Lignol® Alcell® organosolv process for the purposes of increasing the yields of fractionated derivatives of native lignin recovered from fibrous biomass feedstocks during biorefining. Modifications to the Lignol® Alcell® organosolv process conditions included adjusting: (a) ethanol concentration in the pulping liquor to a value selected from a range of 35%-85% (w/w) ethanol, (b) temperature to a value selected from a range of 100° C. to 350° C., (c) pressure to a value selected from a range of 5 atm to 35 atm, and (d) processing time to a duration from a range of 20 minutes to about 2 hours or longer, (e) liquor-to-wood ratio of 3:1 to 15:1 or higher, (f) pH of the cooking liquor from a range of 1 to 6.5 or higher if a basic catalyst is used.

The present invention provides a process for producing derivatives of native lignin, said process comprising:

(a) pretreating (e.g. pulping) a fibrous biomass feedstock with an organic solvent/water solution,

(b) separating the cellulosic pulps or pre-treated substrates from the pulping liquor or pre-treatment solution,

(c) recovering derivatives of native lignin.

The organic solvent may be selected from aromatic alcohols such as phenol, catechol, and combinations thereof; short chain primary and secondary alcohols, such as methanol, ethanol, propanol, and combinations thereof. For example, the solvent may be ethanol. The liquor solution may comprise about 20%, by weight, or greater, about 30% or greater, about 50% or greater, about 60% or greater, about 70% or greater, of ethanol.

Step (a) of the process may be carried out at a temperature of from about 100° C. and greater, or about 120° C. and greater, or about 140° C. and greater, or about 160° C. and greater, or about 170° C. and greater, or about 180° C. and greater. The process may be carried out at a temperature of from about 300° C. and less, or about 280° C. and less, or about 260° C. and less, or about 240° C. and less, or about 220° C. and less, or about 210° C. and less, or about 205° C. and less, or about 200° C. and less.

Step (a) of the process may be carried out at a pressure of about 5 atm and greater, or about 10 atm and greater, or about 15 atm and greater, or about 20 atm and greater, or about 25 atm and greater, or about 30 atm and greater. The process may be carried out at a pressure of about 150 atm and less, or about 125 atm and less, or about 115 atm and less, or about 100 atm and less, or about 90 atm and less, or about 80 atm and less.

The fibrous biomass may be treated with the solvent solution of step (a) for about 1 minute or more, about 5 minutes or more, about 10 minutes or more, about 15 minutes or more, about 30 minutes or more. The fibrous biomass may be treated with the solvent solution of step (a) at its operating temperature for about 360 minutes or less, about 300 minutes or less, about 240 minutes or less, about 180 minutes or less, about 120 minutes or less.

The pH of the pulp liquor may, for example, be from about 1 to about 6, or from about 1.5 to about 5.5.

The weight ratio of liquor to biomass may be any suitable ratio. For example, from about 5:1 to about 15:1, from about 5.5:1 to about 10:1; from about 6:1 to about 8:1.

The volume of extraction solution is from about 5 to about 10 times the volume of the biomass feedstock. For example, the volume of extraction solution may be from about 6 to about 8 times that of the biomass

The present disclosure provides a method of remediating an oil discharge by applying a lignin derivative to said discharge. Surprisingly, it has been observed that lignins can act as an effective sorbent for oils such as crude or refined oil.

The present disclosure provides lignin derivates as sorbents for oil. Any oil may be addressed such as, for example, crude oil; motor oils; mineral oils; organic oils; synthetic oils; petroleum products (e.g. petrol), and the like.

The present lignin derivatives may comprise alkoxy groups. For example, the present lignin derivatives may have an alkoxy content of 2 mmol/g or less; about 1.4 mmol/g or less; about 1.2 mmol/g or less; about 1 mmol/g or less; about 0.8 mmol/g or less; about 0.7 mmol/g or less; about 0.6 mmol/g or less; about 0.5 mmol/g or less; about 0.4 mmol/g or less; about 0.3 mmol/g or less. The present lignin derivatives may have an alkoxy content of 0.001 mmol/g or greater, about 0.01 mmol/g of greater, about 0.05 mmol/g or greater, about 0.1 mmol/g or greater.

The present lignin derivatives may comprise ethoxyl groups. For example, the present lignin derivatives may have an ethoxyl content of 2 mmol/g or less; about 1.4 mmol/g or less; about 1.2 mmol/g or less; about 1 mmol/g or less; about 0.8 mmol/g or less; about 0.7 mmol/g or less; about 0.6 mmol/g or less; about 0.5 mmol/g or less; about 0.4 mmol/g or less; about 0.3 mmol/g or less. The present lignin derivatives may have an ethoxyl content of 0.001 mmol/g or greater, about 0.01 mmol/g of greater, about 0.05 mmol/g or greater, about 0.1 mmol/g or greater.

The present lignin derivatives may have any suitable phenolic hydroxyl content such as from about 2 mmol/g to about 8 mmol/g. For example, the phenolic hydroxyl content may be from about 2.5 mmol/g to about 7 mmol/g; about 3 mmol/g to about 6 mmol/g.

The present lignin derivatives may have any suitable number average molecular weight (Mn). For example, the Mn may be from about 200 g/mol to about 10000 g/mol; about 350 g/mol to about 3000 g/mol; about 500 g/mol to about 2000 g/mol.

The present lignin derivatives may have any suitable weight average molecular weight (Mw). For example, the Mw may be from about 500 g/mol to about 10000 g/mol; about 750 g/mol to about 4000 g/mol; about 900 g/mol to about 3500 g/mol.

The present lignin derivatives may have any suitable polydispersity (D). For example, the D may be from about 1 to about 20; from about 1.2 to about 10; from about 1.3 to about 5; from about 1.4 to about 3.

The present lignin derivatives are preferably hydrophobic. Hydrophobicity may be assessed using standard contact angle measurements. In the case of lignin a pellet may be formed using a FTIR KBr pellet press. Then a water droplet is added onto the pellet surface and the contact angle between the water droplet and the lignin pellet is measured using a contact angle goniometer. As the hydrophobicity of lignins increases the contact angle also increases. Preferably the lignins herein will have a contact angle of about 90° or greater.

The present lignin derivatives preferably have a total hydroxyl content of about 0.1 mmol/g to about 15 mmol/g. For example, the present lignin derivatives may have a total hydroxyl content of from about 1 mmol/g, about 2 mmol/g, 3.5 mmol/g, 4 mmol/g, 4.5 mmol/g, or greater. The present lignin derivatives may have a total hydroxyl content of from about 13 mmol/g, about 11 mmol/g, about 10 mmol/g, about 9 mmol/g, or less.

As used herein the term “total hydroxyl content” refers to the quantity of hydroxyl groups in the lignin derivatives and is the arithmetic sum of the quantity of aliphatic and phenolic hydroxyl groups (OHtot=OHal+OHph). OHal is the arithmetic sum of the quantity of primary and secondary hydroxyl groups (OHal=OHpr+OHsec). The hydroxyl content can be measured by quantitative high resolution ¹³C NMR spectroscopy of acetylated lignin derivatives, using, for instance, 1,3,5-trioxane and tetramethyl silane (TMS) as internal reference. For the data analysis “BASEOPT” (DIGMOD set to baseopt) routine in the software package TopSpin 2.1.4 was used to predict the first FID data point back at the mid-point of ¹³C r.f. pulse in the digitally filtered data was used. For the NMR spectra recording a Bruker AVANCE II digital NMR spectrometer running TopSpin 2.1 was used. The spectrometer used a Bruker 54 mm bore Ultrashield magnet operating at 14.1 Tesla (600.13 MHz for ¹H, 150.90 MHz for ¹³C). The spectrometer was coupled with a Bruker QNP cryoprobe (5 mm NMR samples, ¹³C direct observe on inner coil, ¹H outer coil) that had both coils cooled by helium gas to 20K and all preamplifiers cooled to 77K for maximum sensitivity. Sample temperature was maintained at 300 K±0.1 K using a Bruker BVT 3000 temperature unit and a Bruker BCUO5 cooler with ca. 95% nitrogen gas flowing over the sample tube at a rate of 800 L/h.

Quantification of ethoxyl groups was performed similarly to aliphatic hydroxyls quantification by high resolution ¹³C NMR spectroscopy. Identification of ethoxyl groups was confirmed by 2D NMR HSQC spectroscopy. 2D NMR spectra were recorded by a Bruker 700 MHz UltraShield Plus standard bore magnet spectrometer equipped with a sensitive cryogenically cooled 5 mm TCI gradient probe with inverse geometry. The acquisition parameters were as follow: standard Bruker pulse program hsqcetgp, temperature of 298 K, a 90° pulse, 1.1 sec pulse delay (d1), and acquisition time of 60 msec.

The present disclosure provides a method for remediating an oil discharge, said method comprising:

a. Applying a suitable amount of lignin derivative to discharged oil;

b. Allowing the lignin derivative to interact with the oil, for example, by mixing;

c. Removing at least a portion of the lignin/oil material.

The present disclosure provides a method for remediating an oil discharge on water, said method comprising:

a. Applying a suitable amount of lignin derivative to discharged oil;

b. Allowing the lignin derivative to interact with the oil;

c. Removing at least a portion of the lignin/oil material.

The present disclosure provides a method for remediating a marine oil discharge, said method comprising:

a. Applying a suitable amount of lignin derivative to discharged oil;

b. Allowing the lignin derivative to interact with the oil;

c. Removing at least a portion of the lignin/oil material.

The lignin derivative may be applied in any suitable form to the oil. For example, the lignin derivative may be in particulate form such as a powder, pellet, granule, or the like. The lignin derivative may be applied as a liquid in a suitable solvent. The lignin derivative may be applied as strands, sheets, rolls, pillows, booms, or the like.

The lignin derivative may be applied in any suitable manner to the oil. For example, the lignin derivative may be sprayed from a ship, sprayed from an aircraft, spread by hand or other mechanical means.

The lignin/oil mix may be removed in any suitable manner. For example, the material may be skimmed, dredged, vacuumed, filtered, or combusted.

Once recovered the lignin/oil may be disposed of in any suitable manner. For example, by combustion, bioremediation, safe storage, chemical processing, or the like. In an embodiment of the present disclosure the lignin/oil is combusted. It is an advantage of using lignin as a sorbent as lignins are from a renewable resource which aids in maintaining carbon neutrality. In addition, lignin has a higher heat value compared to other typical sorbents which might add some value to the remediation process if the combustion energy is used for generation of power or other forms of useful energy.

The present disclosure provides a method for remediating an oil discharge on water particularly in a marine environment, said method comprising:

a. Applying a suitable amount of lignin derivative to discharged oil;

b. Allowing the lignin derivative to interact with the oil;

c. In situ burning of at least a portion of the lignin/oil material.

All citations are herein incorporated by reference, as if each individual publication was specifically and individually indicated to be incorporated by reference herein and as though it were fully set forth herein. Citation of references herein is not to be construed nor considered as an admission that such references are prior art to the present invention.

The invention includes all embodiments, modifications and variations substantially as hereinbefore described and with reference to the examples and figures. It will be apparent to persons skilled in the art that a number of variations and modifications can be made without departing from the scope of the invention as defined in the claims. Examples of such modifications include the substitution of known equivalents for any aspect of the invention in order to achieve the same result in substantially the same way.

### EXAMPLES

The following examples are intended to be exemplary of the invention and are not intended to be limiting.

### Example 1

A 100 g sample of Lignol® Alcell® lignin (available from Lignol Innovations Ltd., Burnaby, Canada) was produced in accordance with the method described in U.S. Pat. No. 4,764,596. The lignin was extracted by an autocatalyzed ethanol organosolv method at the following processing conditions—approximately 195° C., 120 min, 50% wt. ethanol, and 6:1 liquor:wood ratio. Once the lignin was extracted, it was precipitated from the black liquor by an acidified water solution and/or stillage having a concentration of solids ˜25%. 200 mL of Esso Extra 20W-50 Engine Oil was added to 1L of deionised water in a water bath

100 g of Lignol® Alcell® lignin derivative was added by hand to the water bath and stirred briefly.

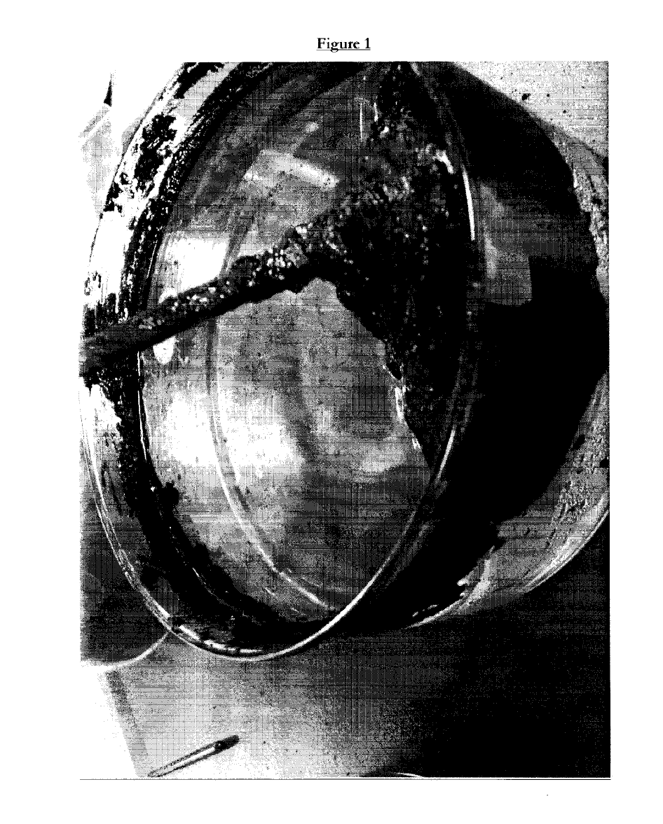

The oil formed a gelatinous mass with the lignin which was easily recovered from the water bath by skimming (FIG. 1).

### Example 2

200 mL of Esso Extra 20W-50 Engine Oil was added to 1L of deionised water in a water bath. 100 g of Indulin AT (available from MeadWestVaco Richmond, Va., USA) was added by hand to the water bath and stirred briefly. The oil formed a gelatinous mass with the lignin which was easily recovered from the water bath by skimming.

### Example 3

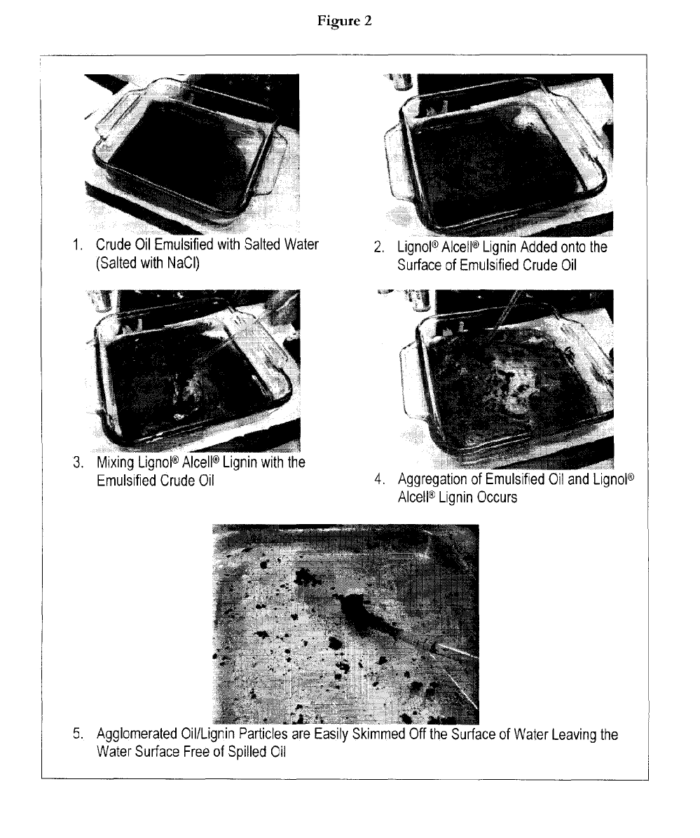

50 mL of crude oil was added to 1 L of salted water in a water bath. 10 g of Lignol® Alcell® lignin (available from Lignol Innovations Ltd., Burnaby, Canada) was added by hand to the water bath and stirred briefly. The oil formed a gelatinous mass with the lignin which was easily recovered from the water bath by skimming (FIG. 2).

1-17. (canceled)

18. A method of using a derivative of native lignin, comprising applying the derivative to an oil discharge as a sorbent.

19. The method of claim 18, wherein the oil is a crude oil.

20. The method of claim 18, wherein the lignin has a total hydroxyl content of from about 0.1 mmol/g to about 14 mmol/g.

21. The method according to claim 18, wherein the lignin derivative is substantially free of sulphur.

22. The method according to claim 18, wherein the lignin derivative is selected from organosolv lignin derivatives.

23. The method according to claim 18, wherein the lignin derivative comprises ethoxy groups.

24. The method according to claim 18, wherein the lignin derivative is hydrophobic.

25. The method according to claim 18, wherein the lignin derivative is derived from hardwood biomass.

26. The method according to claim 18, wherein the lignin derivative is derived from softwood biomass.

27. The method according to claim 18, wherein the lignin derivative is derived from annual fibre biomass.

28. The method of claim 18, wherein the lignin has a phenolic hydroxyl content of from about 2 mmol/g to about 8 mmol/g.

29. The method of claim 18, wherein the lignin has a number average molecular weight (Mn) from about 200 g/mol to about 10000 g/mol.

30. The method of claim 18, wherein the lignin has a weight average molecular weight (Mw) from about 500 g/mol to about 10000 g/mol.

31. The method of claim 18, wherein the lignin has a polydispersity (D) from about 1 to about 20

32. The method of claim 18, wherein the lignin has an alkoxy content of 2 mmol/g or less.

33. A method of remediating an oil discharge, said method comprising:
a) applying a suitable amount of a lignin derivative to discharged oil;
b) allowing the lignin derivative to interact with the oil; and
c) removing at least a portion of the Lignin/oil material.

34. The method of claim 33, wherein the oil discharge is in water.

35. The method of claim 33, wherein the oil discharge is in a marine environment.

36. A method for remediating an oil discharge on water, said method comprising:
a) applying a suitable amount of a lignin derivative to discharged oil;
b) allowing the lignin derivative to interact with the oil; and
c) in situ burning of at least a portion of the lignin/oil material.

37. The method of claim 36, wherein the oil discharge is in a marine environment.
